(19) United States
(12) Patent Application Publication
(10) Pub. No.: US 2005/0006480 A1
(43) Pub. Date: Jan. 13, 2005

(54) Method and apparatus for management of a document generation process

(76) Inventors: Srikrishna Talluri, Southfield, MI (US); Pandurangarao Jetti, Hyderabad (IN)

Correspondence Address: SRIKRISHNA TALLURI;APT # 121, 23730 POND ROAD, SOUTHFIELD, MI, 48034, US

(21) Appl. No.: 10/886,086

(22) Filed: Jul. 7, 2004

Related U.S. Application Data
(60) Provisional application No. 60/485,123, filed on Jul. 7, 2003.

(51) Int. Cl. G06K 7/10

(52) U.S. Cl. 235/468

(57) ABSTRACT

A method and apparatus that generates digital equivalents of physical/paper documents while using non-intrusive, invisible identifiers on each such physical document subjected to the digitization process to optimize future, recurrent digital document generation processes is described. The present invention prints a durable, invisible identifier onto a document the first time it is subjected to a scanning process. The usage of such non-intrusive, invisible identifiers on a document preserves its business and aesthetic integrity while enabling the document to be identified for and by other processes. The digital version of the document and the identifier are stored in a digital archive for further processing. When a set of documents including those already identified are subjected to a subsequent digitization process, the present invention reads the invisible identifier and skips the pre-identified documents from the scanning process, while scanning only those that are new.

### CROSS-REFERENCE TO RELATED APPLICATIONS

This application claims the benefit of priority of U.S. Provisional Patent Application Ser. No. 60/485,123, filed Jul. 7, 2003 and entitled “METHOD AND APPARATUS FOR MANAGEMENT OF A DOCUMENT GENERATION PROCESS”, the subject matter of which is hereby incorporated by reference herein.

### BACKGROUND OF THE INVENTION

This invention relates generally to document management and, more specifically, to a novel and improved method for non-intrusive, aesthetic and unique identification of documents subjected to a repeat run process.

### Data Retention and High Data Availability Regulations

Several government/official agencies have established regulations that mandate the retention of copies of accounting, tax and other financial and business documents for a specified minimum amount of time. Further, similar regulations also mandate high availability of consumer data for businesses that deal with consumer accounts such as banks, stockbrokers, credit card companies, other financial institutions etc.

While business was traditionally conducted using paper media (forms, agreements, other business documents etc.) and all documents were retained in the same paper format, most of the firms nowadays generate a lot of such documents in the electronic form and are moving towards retaining all documents (whether originally generated in paper or electronic forms) in the electronic format itself. Retention of documents in electronic format provides benefits such as enhanced customer service by offering anytime access to pertinent data and enabling self-service, remote access facilitation, easy searching for specific documents (by specific keywords) and quicker retrieval of the documents for the firm, its customers and the regulating agency. Another important benefit is that electronic copies are easily duplicated and the copy may be used to ensure high data availability by serving as a vital backup to protect against and assuage any data loss or damage to the original documents that might occur due to system or network failure or any other reasons.

However, despite the propensity to generate business documents directly in the electronic form itself, a considerable amount of information is outputted onto paper media as several documents need either documentary authentication (such as printout on official, preprinted documents like corporate letterheads or corporate checks) or human authentication (such as signatures) for legitimacy to achieve their intended purpose. Similarly documents may also require other kinds of human input such as selection of one of several available options, entry of specific individual information etc. to achieve their purpose.

### Data Format Conversion and Storage

The propensity exhibited by firms in storing copies of documents in electronic format has meant that a significant amount of time, effort and resources are expended in converting/formatting the generated documents into a suitable electronic format. While documents generated in the electronic form itself (using spreadsheets, word processing software etc.) are converted into images or other formats more suitable for long term retention, documents created on paper media are converted into suitable electronic format by using scanning machines, digital image capturing machines etc. Firms that specialize in offering services for converting paper based documents into electronic formats suitable for long-term retention and maintaining an electronic archive, for other businesses, have now become commonplace.

Further, while the conversion of documents from one electronic format to another is a fairly straightforward process—with the use of specific software that enables automated conversion of several files at a time, the conversion of documents from paper media to an electronic format (despite the use of high-speed scanners) still remains a time-consuming and laborious one. The latter necessitates human involvement in the scanning process as well as for the potentially disruptive withdrawal and eventual re-filing of paper documents from and back to their respective folders. It should be noted here that even while inclining to store copies of documents in electronic format, most businesses continue their normal business practices of storing their paper documents in folders on office shelves to enable their normal business activity. This business routine of using paper-based documents is established corporate behavior and is expected to continue for a good time to come, even if at decreasing levels. The periodic removal of such paper documents could be highly disruptive while also potentially leading to the creation of duplicate electronic copies.

To better illustrate this fact, consider the example of an accounting firm, which uses several folders to hold paper based documents generated for its clients. To abide by mandated data retention and/or high availability regulations, the firm periodically converts and backs-up all documents to electronic format by using a high-speed scanner. The folders along with the documents are then placed back onto the shelves to enable normal business activity. It should be noted that between successive scanning processes, several documents generated for clients in the course of regular business activity are placed in their respective folders.

To optimize the next scanning process, it would be ideal to scan only those documents that have been generated since the last process. Identifying all documents that have been subjected to the scanning process and preventing them from being run once again through the scanner could ideally achieve this purpose. Alternatively, each new document generated (since the last scanning process) could be visually marked/tagged before placing them in a particular folder or by placing new documents in an interim folder until they are scanned and converted into electronic format.

The use of special marks or patterns on documents is known in prior art. Examples are U.S. Pat. No. 6,563,598 to Johnson, et al., U.S. Pat. No. 5,893,124 to Ogaki, et al., U.S. Pat. No. 5,207,412 to Coons, Jr., et al., U.S. Pat. No. 5,978,620 to Syeda-Mahmood—all of which are hereby incorporated by reference. However, all these methods use visually identifiable patterns and markings on instruction sheets that are precursors to actual jobs (scanning, copying etc.).

In the current scenario, visually identifiable marking cannot be used because such markings would impinge on the aesthetic or business value of the document. Further, placing documents in an interim folder would lead to unnecessary additional time consuming steps, potential disruption of normal processes, avoidable large scale redundancy and could cause more disruption while taking up additional time and resources for monitoring the same.

Further complicating the scenario is the fact that between two such scanning processes, additional folders might have been created to hold more (paper) documents and documents placed in one folder may now have been moved to another.

The problems here are to avoid the creation of duplicate copies of documents that have already been scanned (and saved in electronic format) while enabling effective and efficient capture and creation of electronic versions of all paper based documents.

It is therefore desirable to overcome present limitations and solve problems in the prior art.

### BRIEF SUMMARY OF THE INVENTION

Accordingly, it is an object of the present invention to provide a method and apparatus to optimize a recurrent digital document generation process using non-intrusive, invisible identifiers on each physical document subjected to the process.

It is another object of the present invention to uniquely and non-intrusively identify each physical/paper document subjected to the document generation process.

It is yet another object of the present invention to provide a method and apparatus to search for and read existing identifiers on the physical document.

It is still yet another object of the present invention to provide a method and apparatus that performs a function in response to the presence of the identifier on the physical document.

It is still yet another object of the present invention to provide a method and apparatus that uses an identifier to trigger time-based actions to be carried out by the system.

It is still yet another object of the present invention to track and enable easy location of papers based documents.

It is still yet another object of the present invention to automatically generate metadata for the scanned document.

### BRIEF DESCRIPTION OF THE SEVERAL VIEWS OF THE DRAWING

FIG. 1 is a block diagram of an embodiment illustrating a method of capturing and integrating images and data in accordance with the present invention.

### DETAILED DESCRIPTION OF THE INVENTION

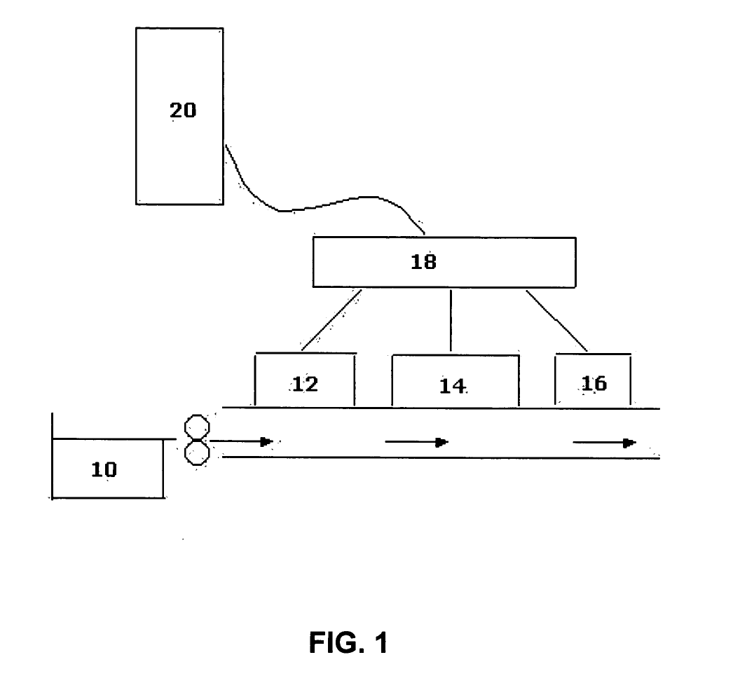

FIG. 1 is a block diagram of the illustrative embodiment of the present invention. The embodiment consists of a document feeding element 10, an image reading element 12, a scanning element 14 and a printing element 16. All these elements are communicatively coupled to the central processor 18. The documents to be scanned are placed into the document feeder 10. This is connected to a computer 20. Arrows depict the document path. As the document moves through the apparatus, the image reader 12 first searches for the presence of an identifier on the document. If no identifier is found on the document, it is then scanned and converted into an electronic format by the scanning element 14. Then as the document passes through the far end of the apparatus, the printing element 16 prints an identifier onto the document. This identifier imprinted onto the paper document is invisible to the naked eye but can be read by a suitable optical sensor/image reader when excited by light of suitable frequency. The image reader 12 in this embodiment is capable of exciting and reading the invisible marking by projecting light of suitable frequency onto the same.

This invisible marking printed on the document, being non-intrusive, preserves the aesthetic and business value of the document. This invisible unique identifier may also contain the date and time it was printed as well as the name of the folder that it belongs to. The user enters the name of the folder before beginning the scanning job for a particular folder either through the computer or by using a control keypad (not shown) on the apparatus.

The electronic/digital version of the paper document thus generated is stored along with the unique identifier in a digital archive on the computer 20. Further, metadata for the scanned document may be generated and stored in the archive—along with the electronic/digital copy of the document.

During a subsequent scanning process, the process described above is repeated. The image reader 12 first reads the documents and notifies the processor 18 if it reads an identifier on a document. The processor 18 verifies the identifier with the digital archive on the computer 20 and instructs the scanning element 14 to bypass scanning of the document, as it already exists in the digital archive. The document is also bypassed by the printer 16, as the document has already been scanned and identified in a previous run. However, to preserve the identifier on the document even after the document has been subjected to several such processes and to account for degeneration in the signal given out by the invisible marking (which may be caused by frequent usage of the document in normal business processes), the processor 18 may be ordered to further instruct the printer 16 to re-print the identifier onto the document.

However, if a document has been moved from the folder it was previously in, the new folder name (as entered by the user prior to scanning) is now appended to the pertinent record in the digital archive. This further helps in locating a paper-based document that may have been erroneously misfiled during normal business activity by looking up the present location (at the time of scanning) mentioned in the digital archive.

Such a process gives the end-users the flexibility to move documents from one folder to another, which is expected in normal business activity, while also enabling easy tracking of the same.

In the foregoing specification, the invention has been described with reference to an illustrative embodiment thereof. However, it will be evident that various modifications and changes may be made thereto without departing from the broader spirit and scope of the invention. The specification and drawings are, accordingly, to be regarded in an illustrative rather than a restrictive sense. Therefore, it is the object of the appended claims to cover all such modifications and changes as come within the true spirit and scope of the invention.

1. A method and apparatus to optimize a recurrent digital document generation process using non-intrusive, invisible identifiers on physical documents subjected to a scanning process.

2. An apparatus of claim 1, which contains: a printing element that uses invisible ink,
one or more scanning elements to scan and read invisible ink,
one or more scanning elements to scan regular ink documents.

3. A method and apparatus of claim 1, where each physical/paper document subjected to the document generation process is uniquely and non-intrusively identified.

4. A method and apparatus of claim 1, where existing identifiers on the physical document may be read.

5. A method and apparatus of claim 1, where a function is performed in response to the presence of the identifier on the physical document.

6. A method of claim 1, where the document being scanned is an agreement between two or more parties onto a legally designated form with corresponding legal insignia.

7. A method of claim 1, where the document being scanned is opaque, translucent or transparent paper.

8. A method and apparatus, where documents may be scanned to create their digital versions, wherein an invisible identifier is imprinted on the physical document upon being scanned,
thereafter the digital version of the scanned document is stored in a digital archive along with the actual name of identifier.

9. A method of claim 8, where metadata is automatically generated for the scanned document and stored with the digital version of the document.
